(19) United States
(12) Patent Application Publication
(10) Pub. No.: US 2016/0019524 A1
(43) Pub. Date: Jan. 21, 2016

(54) METHODS AND DEVICES FOR CONFIRMING A FINANCIAL TRANSACTION

(71) Applicants: AVRAHAM ROTH, Givat Shmuel (IL); AMIR KIRSH, Zafaria (IL)

(72) Inventors: AVRAHAM ROTH, Givat Shmuel (IL); AMIR KIRSH, Zafaria (IL)

(21) Appl. No.: 14/333,516

(22) Filed: Jul. 17, 2014

(51) Int. Cl. G06Q 20/32; G06Q 20/02; G06Q 20/22; G06Q 20/04

(52) U.S. Cl. CPC G06Q 20/322; G06Q 20/045; G06Q 20/02; G06Q 20/22

(57) ABSTRACT

The invention discloses devices and methods for providing feedback on purchases. In some embodiments, a physical or virtual receipt as used as an intermediary to delivery to a smartphone or other user-specific device details of a recent purchase. In some embodiments, the details may alternatively or additionally be transferred to a third party including but not limited to a vendor or a credit card provider. In the latter arrangement, the credit card provider may choose to contact the owner of the credit card to verify that a transaction in question has taken place. Contact may take the form of a phone call, SMS, email, or the like. In some embodiments owner of the credit card may contact the provider via a smartphone or similar device.

### FIELD AND BACKGROUND OF THE INVENTION

The present invention, in some embodiments thereof, relates to methods and devices for allowing for real-time confirmation of credit card transactions. The instant invention, in some embodiments, allows for prevention of identity theft via credit card misuse.

The Internet has revolutionized modern lifestyles. Beyond the obvious uses such as communication, commerce, and recreation, the Internet has changed the way we interact with the world immediately around us. Amazon and other online merchants have become enormous retailers to Americans and citizens of countries around the globe. The main route for payment on Amazon and other Internet merchants involves credit card or similar payments, like PayPal. The absolute safety of such means of transactions is critical for guaranteeing the continued growth of Internet and Web-based commerce. The number one concern of consumers with online purchases is the safety of their personal and financial information. Many consumers fail to consummate purchases, with safety to personal data considered the main reason for not finishing online transactions.

Credit cards preceded smartphones by several decades. Much of the way credit cards are processed and treated today dates from the early days of credit card access and use. A credit card user generally receives notification of a specific transaction once a month. The information provided is minimal—the date of the transaction, the store where the purchase was made and the final cost. On the other hand, smartphones are designed for instant communication and detail. SMS, WhatsApp, cellular calls, email, and other forms of communication give instant transfer of information in one or two directions. As each smartphone has a unique telephone number that—like a credit card—guarantees its relationship to a specific owner, the smartphone may be the ideal device for providing real-time credit card and other purchase information that would greatly reduce the risk of consumer identity theft that still relies heavily on the delay between a purchase and notification of a card user to that purchase.

International Patent Application PCT/KR2012/006633 teaches a credit card transaction method using a smartphone, which does not use a credit card sales slip. More particularly, the present invention relates to a credit card transaction method in which credit card authorization information is transmitted to the smartphone of a user when the user uses a credit card, signature data is transmitted to a credit card company to obtain normal authorization when the user enters a signature to the smartphone to which the authorization has been transmitted, and a slip is transmitted to the smartphone from the store in which the payment is being performed by the credit card, thus normally performing a credit card transaction without a credit card sales slip. The credit card transaction method of the present invention comprises an authorization request step, a preliminary authorization transmitting step, a signing step, a signature transmitting step, a signature comparing step, and a slip transmitting step. According to the present invention, a printed sales slip is not used in order to save resources, a credit card company server checks whether or not a signature corresponds to the registered signature information instead of determining authorization by means of only a telephone number, to thereby enable accurate user authentication and thus enable the safe use of a credit card. Further, information on the credit card usage of the user is recorded on his/her smartphone, thus enabling the user to manage his/her usage at the same time.

U.S. Pat. No. 8,751,601 to Slonh describes method and apparatus of providing notifications to a mobile station user. The method may include receiving a user registration for a notification application and storing the user registration information in a notification database. The method may also include receiving a business entity designation from the mobile station identifying at least one business entity from which the user desires to receive notifications. The method may also include transmitting a notification to the mobile station in response to the business entity designation.

U.S. patent application Ser. No. 13/835,586 to Orozco et al. teaches a mobile application for sending alerts to a bank's customer. The mobile application allows a customer to receive alert notifications regarding transactions on his or her bank or credit card accounts when a debit or credit card associated with the account is used. The mobile application server and adjoining intermediate database, which stores the customer's alert information, is in communication with the bank's or ISO's server and their adjoining customer database to receive transaction data. The mobile application server sends alert notifications through a customer's or user's mobile app after processing the communication, which displays the information on the customer's smartphone or electronic tablet. Customer may choose to send a response back through the mobile application server to the bank's or ISO's server and their adjoining customer database, reporting suspected fraud or approving the transaction using the customer's unique pin code or password.

### SUMMARY OF THE INVENTION

It is therefore a purpose of the present invention, in some embodiments, to describe methods and devices for allowing real-time, secure confirmation of a credit or debit card transaction. In some embodiments of the invention, a smartphone may be employed to either send and/or receive confirmation data of a credit card or other financial transaction immediately prior to or after the transaction.

The invention includes a system for preventing misuse of a credit card, including: a credit/debit card adapted to be used for commercial transactions; a cash register adapted to send predetermined details of at least one commercial transaction involving a purchase with the credit/debit card to a provider of the credit/debit card; a handheld computing device adapted to receive the predetermined details or a portion thereof; and, a communication means between the provider and the handheld computing device.

In one aspect of the system, the cash register is further adapted to send the predetermined details or a portion thereof to the handheld computing device.

In another aspect of the system, the cash register is further adapted to print a paper receipt of the transaction.

In another aspect of the system, the receipt is adapted to include a code for identifying the at least one commercial transaction.

In another aspect of the system, the code is adapted to be scanned by the handheld computing device.

In another aspect of the system, the handheld computing device is adapted to include at least one application adapted to interpret the code.

In another aspect of the system, the application is adapted to send confirmation of the at least one transaction to the provider.

In another aspect of the system, the application is further adapted to receive a confirmation of the at least one transaction from the provider.

In another aspect of the system, the handheld computing device is realized as a smartphone, a cellular phone, a tablet computer, a wearable computing device, a watch computing device, Google Glass, a laptop computer, or a mobile electronic device.

In another aspect of the system, the communication means between the cash register and the computing device is realized as cellular network, WiFi, IR, Bluetooth, RF, RFID, NFC, SMS, MMS, IP Push, sound signals or communication over application API.

In another aspect of the system, the code is realized as a bar code a QR code, a numerical code, an alphanumerical code, or a symbol code.

The invention includes a method for preventing credit card fraud, including: providing a credit/debit card; performing a purchase of at least one good or service with the credit/debit card via a cash register; sending predetermined details of the purchase to a provider of the credit/debit card; sending the predetermined details of the purchase to a handheld computing device associated with an owner of the credit/debit card; and, exchanging information regarding the purchase between the provider and the handheld computing device to confirm the validity of the purchase.

In one aspect of the method, the sending predetermined details is performed by the cash register or a server in communication with the cash register.

In another aspect of the method, there is additionally a step of sending a subset of the predetermined details to at least one third party.

In another aspect of the method, the credit/debit card is realized as a plurality of credit/debit cards.

In another aspect of the method, the plurality of credit/debit cards is associated with a single or a plurality of users.

In another aspect of the method, the plurality of users is realized as members of a family, organization, company, country, group, or industry.

The invention includes a system for preventing misuse of a means of payment, including: a means of payment adapted to be used for commercial transactions; a cash register adapted to send details of at least one commercial transaction involving a purchase with the means of payment to a provider of the means of payment; a receipt produced by the cash register, the receipt adapted to include a code identifying details related to the at least one commercial transaction; a handheld computing device adapted to receive the information or a portion thereof; and, a communication means between the provider and the handheld computing device.

In one aspect of the system, the code is a QR code, a bar code, a alphanumeric code, or a symbol code.

In another aspect of the system, the receipt is realized as a digital receipt on the handheld computing device.

Unless otherwise defined here or in the embodiments, all technical and/or scientific terms used herein may have their same meaning as commonly understood by one of ordinary skill in the art to which the term pertains.

A “cash register” may refer to any device, system, or element that is adapted, at least in part, to perform a financial transaction. Non-limiting examples include traditional cash registers found at checkouts of stores, ATM's, gas pumps adapted to record credit card transactions, self-checkout systems, hand-portable credit card processing devices, online payment systems, and the like. A cash register may be adapted to record and save transiently or permanently transactional data and may be further adapted to send said data or a portion thereof to another device such as a server or a mobile computing device. A cash register may include any of its components such as but not limited to front end components, back office components such as store servers, regional servers, retailer's servers, cashier manufacturer servers and the like. A point of sale (POS) may be considered a cash register for the instant invention.

“Mean(s) of payment” may include without limitation any of the following: checks, credit cards, debit cards, pre-paid cards, travelers checks, bitcoin, money transitions, wire transfer, clearing house services (such as PayPal), electronic wallet, payments through cellular account, parking account or any other accounts such as electricity account, and the like.

A “credit card” may refer to a credit card, debit card, PayPal, bank transfer protocol, wire transfer, check or other payment element adapted to allow a transfer of funds from a defined individual or group (unlike say, cash) in exchange for goods, services, or the like.

“Server”, “cloud” and “cloud computing” may have their generally understood meaning in the Internet arts. A “receipt” may be digital, physical, virtual, or paper-based.

A “mobile computing device” may generally refer to a device or element adapted to perform computational actions. Non-limiting examples of a mobile computing device include smartphones, hand-held computers, Google Glass, smart watches, tablet computers, laptop computers, and the like.

A “smartphone” may have its generally understood meaning.

A “code” may generally refer to a symbol, picture, barcode, QR code, or the like adapted to be scanned by a smartphone camera, digital camera or similar device. A code may further be adapted to be interpreted by an application (app) or program associated with a mobile computing device. A code generally includes information on a purchase performed by an owner of a mobile computing device.

A credit/debit card or means of payment “provider” may generally be realized as a bank, financial institution, credit union or other body that provides a credit/debit card or similar instrument adapted to allow for purchases with said credit/debit card or similar instrument. A bank that issues credit cards is a non-limiting example of a provider according to some embodiments of the instant invention.

“Validity” may generally mean that a given transaction or plurality of transactions has actually taken place.

“Communication mean(s)” may refer to wired or wireless communication between a cash register and a computing device may generally be realized as cellular network, WiFi, IR, Bluetooth, RF, RFID, NFC, SMS, MMS, IP Push, sound signals or communication over application API.

A “commercial transaction” may generally refer to any action whereby a first party pays a second party for a service, item and/or good owned by or belonging to second party. Cash payments, credit card and debit card payments for goods and services, wire transfers for payment and bartering are non-limiting examples of commercial transactions.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100. Several black-and-white photographs have been incorporated into the Figures as they add to the understanding of the instant invention.

In the drawings:

FIG. 1 shows a flowchart of a method associated with an embodiment of the instant invention;

FIGS. 2A-2F show schematic views of arrangements consistent with the method of FIG. 1;

FIGS. 3-5 show schematic view of arrangement consistent with a device embodiment of the instant invention;

FIGS. 6-7 show schematic view of arrangement consistent with an alternative device embodiment of the instant invention; and,

FIGS. 8A-8G show non-limiting examples of mobile computing devices.

### DESCRIPTION OF SPECIFIC EMBODIMENTS OF THE INVENTION

The present invention, in some embodiments thereof, relates to methods and devices for creating a high degree of credit card safety by confirming a transaction at the user and provider level immediately prior to or immediately after a transaction takes place.

The instant invention, in some embodiments, addresses an important issue in an exponentially growing market. Companies like Amazon, Alibabi (and Aliexpress) and eBay cannot function without online transactions. Yet, every year, hundreds of millions of credit cards are compromised, and millions find themselves paying for goods and services that they never ordered or used. Tens of millions of others have to change credit cards due to apparent security breaches, such as the massive one that occurred at Target in late 2013. How can a tightly-knit global business community continue to function when people are terrified that their personal data may be compromised, and even before they get home, they will have absorbed thousands of dollars of phony expenses? One of the major problems with credit card (and debit card, PayPal and similar schemes) systems is that most users are not informed of their purchases until a fixed day of the month—and as such, misuse of a user's data may go on for days or weeks before anyone becomes wiser to the fraud.

The instant invention, in some embodiments, takes advantage of a unique set of conditions that exist today: just as a credit card has a unique number that ties it exclusively to a specific card holder, so too a smartphone has a unique phone number (and also email address and other communication features like a Skype number) that ties it to the same user. As smartphones offer incredibly fast and reliable communication possibilities, the ability exists for a user and a credit card provider (“provider”) to communicate one with another to confirm in real time that a particular purchase actually took place. Should one party balk at the other's claim, then an immediate analysis may be launched to cut identify theft early, before it can claim large financial damages.

### First Embodiment

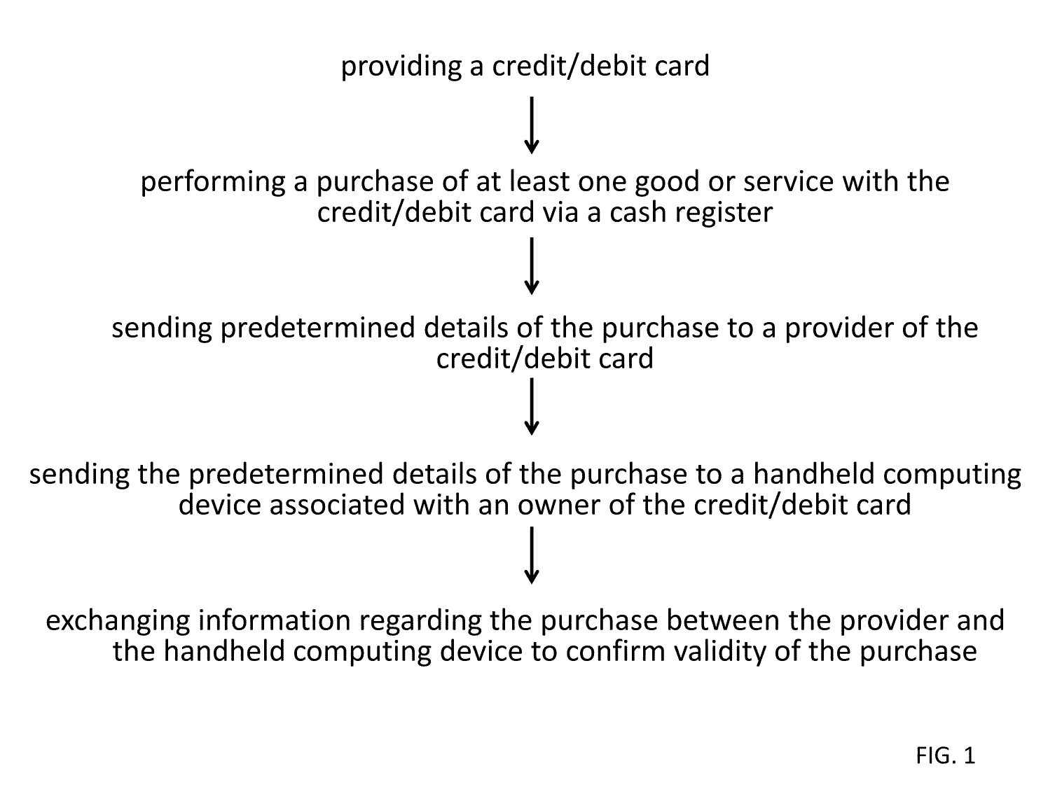

Attention is turned to FIG. 1, which shows a flowchart of a method associated with an embodiment of the instant invention. The invention includes a method for preventing credit card fraud, including: providing a credit/debit card; performing a purchase of at least one good or service with the credit/debit card via a cash register; sending predetermined details of the purchase to a provider of the credit/debit card; sending the predetermined details of the purchase to a handheld computing device associated with an owner of the credit/debit card; and, exchanging information regarding the purchase between the provider and the handheld computing device to confirm the validity of the purchase.

In one aspect of the method, the sending of predetermined details is performed by the cash register or a server in communication with the cash register. In another aspect of the method, there is additionally a step of sending a subset of the predetermined details to at least one third party. In another aspect of the method, the credit/debit card is realized as a plurality of credit/debit cards. In another aspect of the method, the plurality of credit/debit cards is associated with a single or a plurality of predetermined users. In another aspect of the method, the plurality of predetermined users is realized as members of a family, organization, company, country, group, or industry.

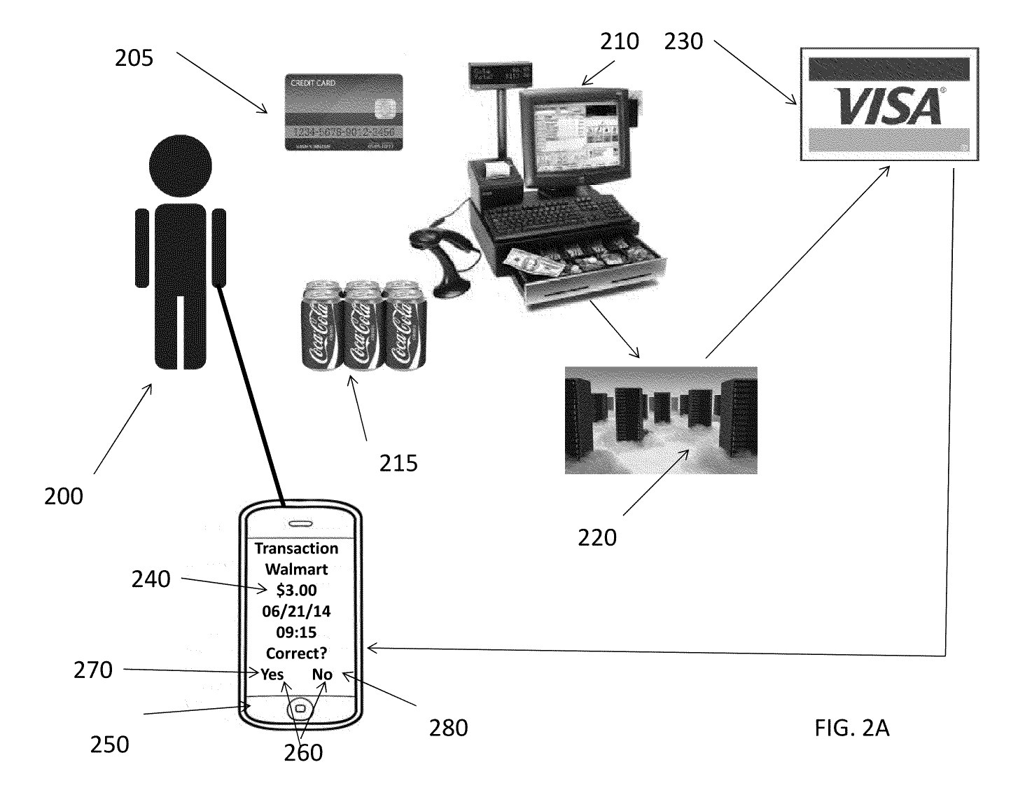

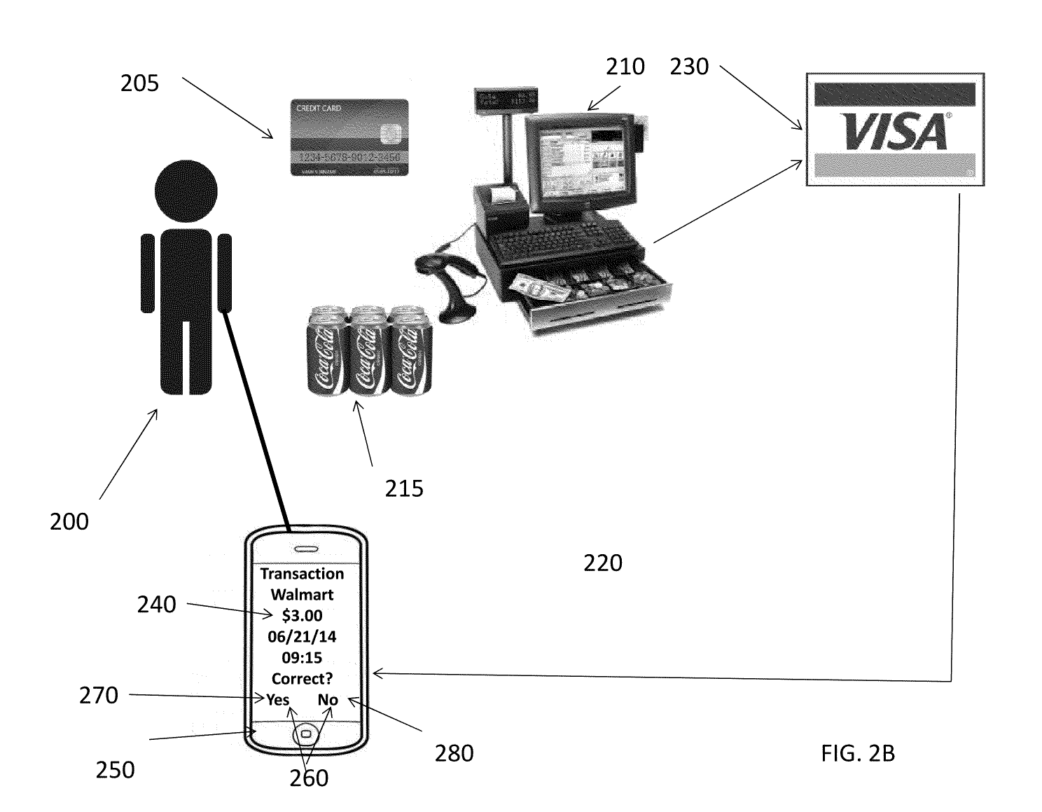

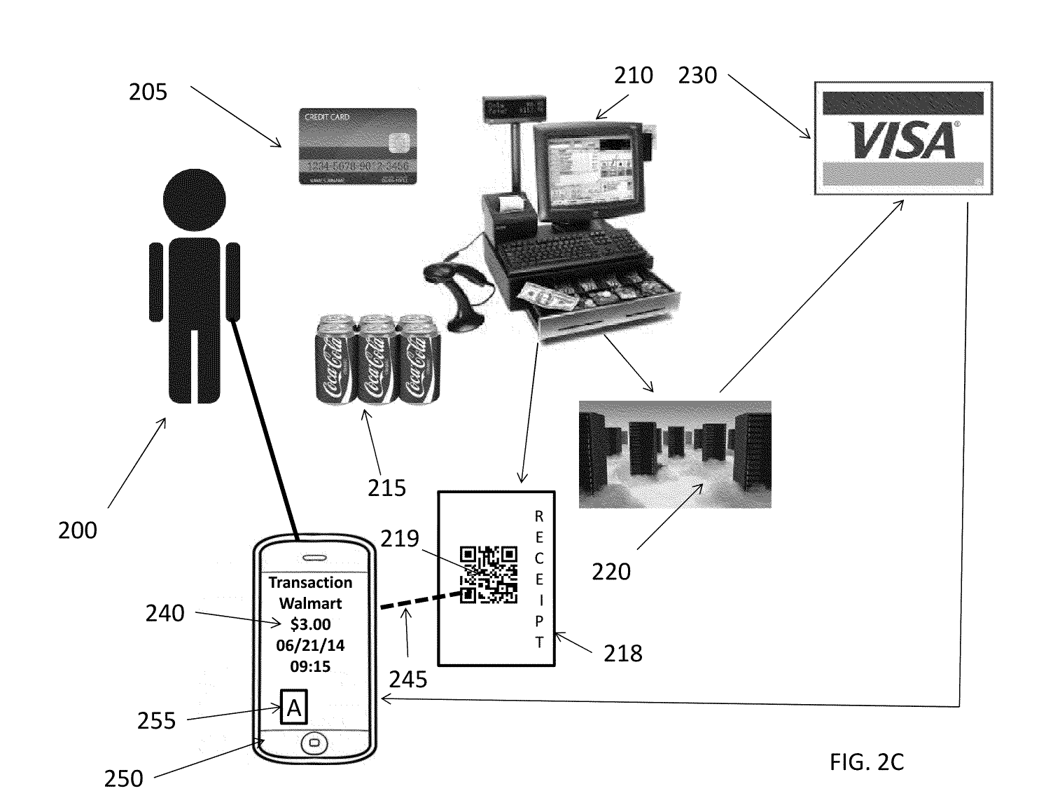

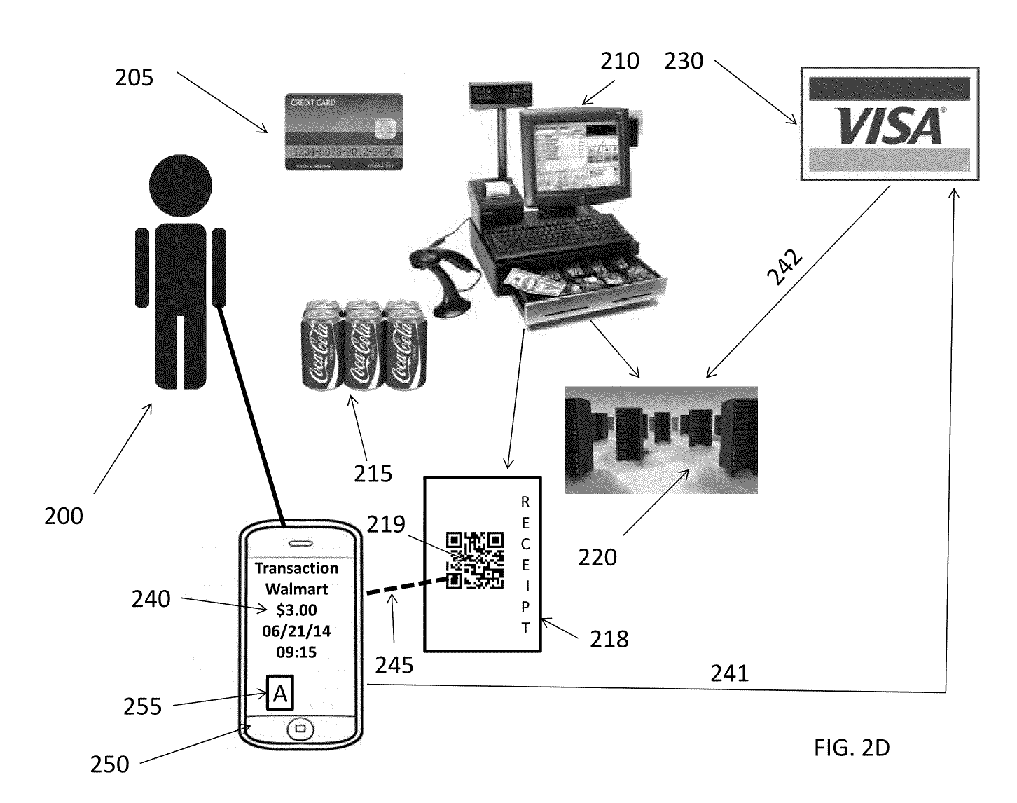

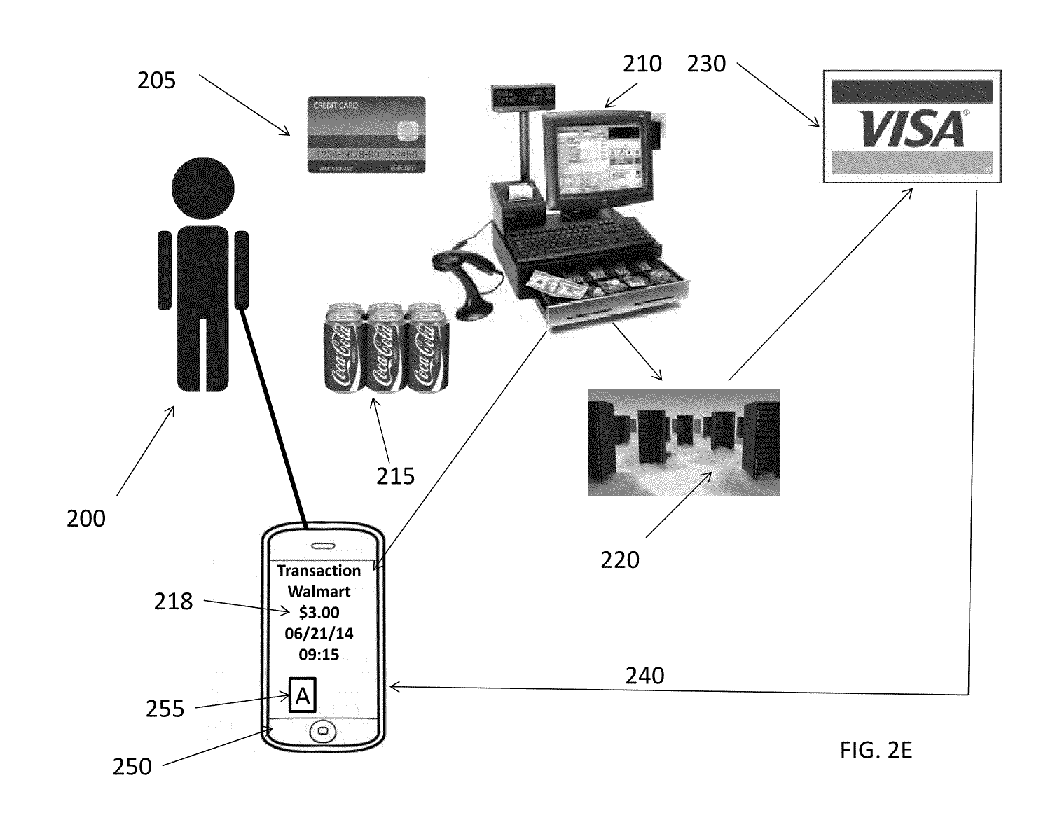

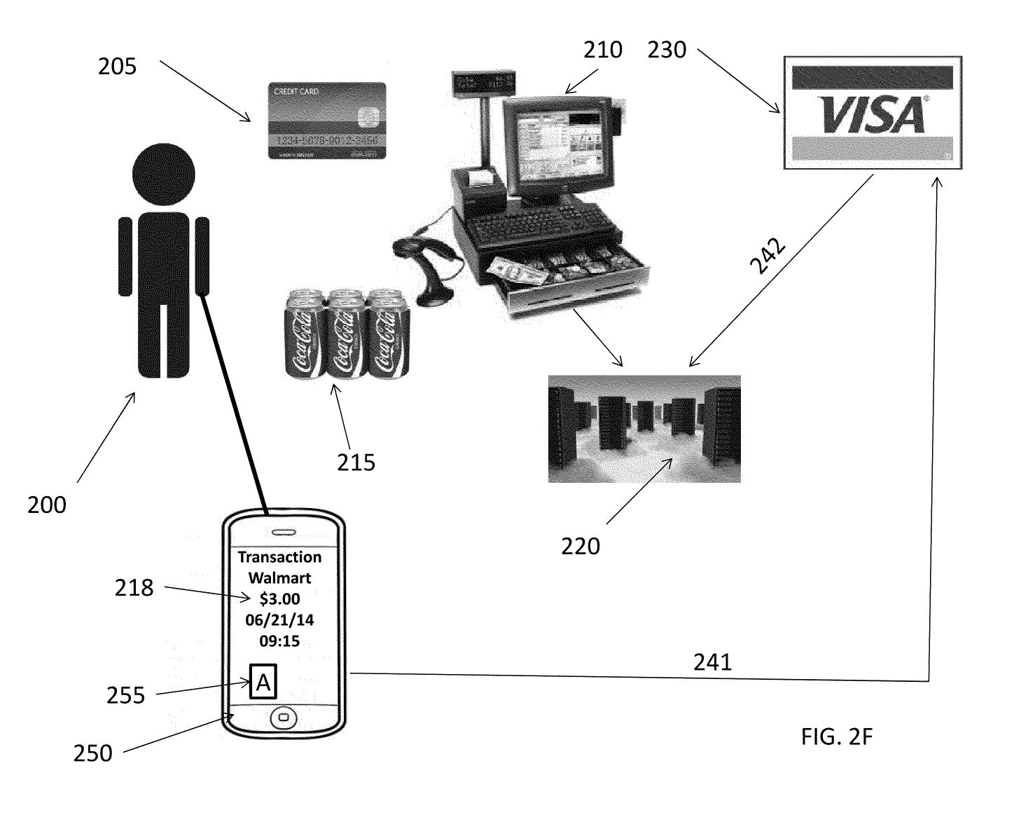

FIG. 2A shows a case of the instant embodiment. A user 200 provides a credit card 205 which is employed via a cash register 210 to allow the purchase of at least one good or service 215. The cash register 210 sends data regarding the purchase, such as the last four digits of the credit card 205 number, date and time of purchase, location of purchase, and amount paid, to a network 220 associated with the cash register 210. The data from the network are sent to the credit card 205 provider 230 where the details are recorded. The credit card provider 230 sends a message 240 to a smartphone 250 or similar mobile computing device uniquely associated with user 200 whose credit card 205 was involved in the purchase. The message may be in the form of a phone call, an SMS, a WhatsApp note, an email, a FAX, an app notification, or other relevant message that is directed to the unique phone number and/or email address of the user 200. User is given an option 260 to reply to provider 230 that he/she has performed the transaction as described. Should user 200 answer affirmatively 270, the provider may record the transaction as confirmed. Should user claim that he/she did not 280 perform the transaction with the credit card 205, then provider may take appropriate action, including but not limited to shutting down the card 205, contacting the user 200 by phone, contacting police and/or financial authorities, contacting the seller who sent the data, and ordering a new credit card for user 200. It is understood that the data could be sent to the provider 230 prior to completion of the credit card 205 transaction, with completion dependent on user 200 signaling that he/she is indeed performing the transaction in question prior to payment. The network 220 may be a store-wide network and/or may involve a cloud computing arrangement allowing flow of data for a plurality of cash registers 210 associated with a plurality of stores. The network 220 may be realized as an Intranet system, a VPN system, a company-wide network, national network, international network, or a part of an additional network.

Attention is turned to FIG. 2B It is shown in this aspect of the instant embodiment that cash register 210 may be adapted to communicate directly with provider 230 without recourse to a network. A user 200 provides a credit card 205 which is employed via a cash register 210 to allow the purchase of at least one good or service 215. The cash register 210 sends data regarding the purchase, such as the last four digits of the credit card 205 number, date and time of purchase, location of purchase, and amount paid, to a provider 230 of the credit card 205 or its representative. The credit card provider 230 sends a message 240 to a smartphone 250 or similar mobile computing device uniquely associated with user 200. The message may be in the forms of a phone call, an SMS, a WhatsApp note, an email, a FAX, or other relevant message that is directed to the unique phone number and/or email address of the user 200. User is given an option 260 to reply to provider 230 that he/she has performed the transaction as described. Should user 200 answer affirmatively 270, the provider may record the transaction as confirmed. Should user claim that he/she did not 280 perform the transaction with the credit card 205, then provider may take appropriate action, including but not limited to shutting down the card, contacting the user by phone, contacting appropriate authorities, contacting the seller who sent the data, and/or ordering a new credit card for user 200. It is understood that the data could be sent to the provider 230 prior to completion of the credit card 205 transaction, with completion dependent on user 200 signaling that he/she is indeed performing the transaction in question.

It is noted from the description above that for a credit card thief to succeed, he/she would need not only credit card 205 details, but also a user's smartphone 250 or similar device. Even should a thief obtain both, most smartphones 250 can be locked and/or disabled. Should a credit card 205 thief attempt to make a purchase but be unable to access the stolen smartphone 250, the provider 230 would invalidate a purchase, when the real user 200 fails to corroborate the purchase made. Thus, even a thief who steals a credit card 205 and smartphone 250 in the middle of the night and tries to make purchases before user 200 becomes aware of his/her missing belongings, provider 230 can deactivate the card for failure of the thief in responding to requests for purchase confirmation sent to the user's ostensibly locked smartphone 250.

FIG. 2C shows an additional version of the instant method. A user 200 provides a credit card 205 which is employed via a cash register 210 to allow the purchase of at least one good or service 215. The cash register 210 generates a physical receipt 218 which is provided to user 200. The receipt 218 is adapted to include a code 219 that may be scanned 245 by a camera associated with a smartphone 250 or similar device. The code 219 may be a QR code, a barcode, an alphanumeric, symbol, or object code. At the time of transaction, the cash register 210 also sends data regarding the purchase, such as the last four digits of the credit card 205 number, date and time of purchase, location of purchase, amount paid, and cash register number to a network 220 associated with the cash register 210. The data from the network are sent to the credit card 205 provider 230 where the details are recorded. Obviously, the data from the cash register 210 may be sent directly to the provider 230 as previously described. The credit card provider 230 sends a message 240 to a smartphone 250 or similar mobile computing device uniquely associated with user 200 as per records of the provider 230. The message may be in the form of a phone call, an SMS, a WhatsApp note, an email, a FAX, or other relevant message that is directed to the unique phone number and/or email address of the user 200. The smartphone is adapted to include an application 255 adapted to compare the message 240 with data received from provider 230 and the data scanned 245 from the receipt 218 code 219. If the data match, the application may be adapted to inform the provider that the purchase in question took place. User 200 may also be alerted, if he/she so desires. If the data do not much, or if there is no receipt to scan, then the application will alert the provider 230 of the inconsistent data. Provider 230 may choose to investigate the matter further and/or temporarily suspend the credit card 205 until user 200 is consulted.

Attention is turned to FIG. 2D. FIG. 2D shows an additional version of the instant method. A user 200 provides a credit card 205 which is employed via a cash register 210 to allow the purchase of at least one good or service 215. The cash register 210 generates a physical receipt 218 which is provided to user 200. The receipt 218 is adapted to include a code 219 that may be scanned 245 by a camera associated with a smartphone 250 or similar device. The code 219 may be a QR code, a barcode, an alphanumeric, symbol, or object code. The code is embedded with information that may be realized as data regarding the purchase, such as the credit card 205 number or a part thereof, date and time of purchase, location of purchase, cashier number and amount paid, to a network 220 associated with the cash register 210. The code 219 may be scanned by a smartphone 250 whose telephone number is associated by the provider 230 with the user 200 and his/her credit card 205. The scanned code 219 provides data on the purchase; these data may be forward 241 to provider 230, who then confirms 242 purchase time and data with a server 220 or network associated with the cash register 210. If the data sent by the smartphone 250 match the data on the server 220 or network, then the provider 230 approves the purchase and/or records the purchase as correct. The smartphone 250 is adapted to include an application 255 adapted to send data scanned 245 from the receipt 218 code 219 and send it by any predetermined relevant wireless means to the provider 230. Wireless means may include cellular call, SMS, email, WhatsApp, or the like. User 200 may also be alerted that data have been sent by the application 255, if he/she so desires. If provider 230 cannot confirm the purchase data sent by the application 255, user 200 may be alerted and his/her credit card 205 may be frozen.

FIG. 2E shows an additional version of the instant method. A user 200 provides a credit card 205 which is adapted to be employed via a cash register 210 to allow the purchase of at least one good or service 215. The cash register 210 generates a virtual receipt 218 adapted to be wirelessly sent to a user's 200 smartphone 250 or similar device by the cash register 210 or an associated server 220 or network, including a cloud network. The smartphone 250 is identified as belonging to user 200 by virtue of a unique identifier, generally a telephone number or an email address, for example. At the time of transaction, the cash register 210 may also send data regarding the purchase, such as the last four digits of the credit card 205 number, date and time of purchase, location of purchase, and amount paid, to a network 220 associated with the cash register 210. The data from the network are sent to the credit card 205 provider 230 where the details are recorded. Obviously, the data from the cash register 210 may be sent directly to the provider 230 as previously described. The credit card provider 230 sends a message 240 to the smartphone 250 uniquely associated with user 200. The message may be in the form of a phone call, an SMS, a WhatsApp note, an email, a FAX, or other relevant message that is directed to the unique phone number and/or email address of the user 200. The smartphone is adapted to include an application 255 adapted to compare the message 240 with data received from provider 230 and the data received with the virtual receipt 218. If the data match, the application is adapted to inform the provider that the purchase in question took place. User 200 may also be alerted, if he/she so desires. If the data do not much, or if no virtual receipt 218 is received by user 200 smartphone 250, then the application may alert the provider 230 of the inconsistent data. Provider 230 may choose to investigate the matter further and/or temporarily suspend the credit card 205 until user 200 is notified.

Attention is turned to FIG. 2F. FIG. 2F shows an additional version of the instant method. A user 200 provides a credit card 205 which is employed via a cash register 210 to allow the purchase of at least one good or service 215. The cash register 210 generates a virtual receipt 218 which is provided to user 200 smartphone 250 or similar device via a wireless transfer to said smartphone 250 or similar device. Provision of the virtual receipt 218 may occur by cellular means, by SMS, by Bluetooth, IR, or other means. The receipt 218 includes data on the purchase such as the date, hour, amount, location of purchase, and last four digits of card 205 employed in the purchase. The smartphone 250 is adapted to include an application 255 adapted to send 241 data the virtual receipt 218 wirelessly or otherwise to the provider 230. Provider 230 may check data received from cash register 210 via a server 220 or network, and if the data from the server 220 or network and the smartphone are identical, provider may record the transaction as authentic. If data are inconsistent and/or lacking, provider 230 may refuse to process the transaction or may recall payment. User 200 may also be alerted that data have been sent by the application 255, if he/she so desires. If provider 230 cannot confirm the purchase data sent by the application 255, user 200 may be alerted and his/her credit card 205 may be frozen or cancelled.

### Second Embodiment

The invention includes a system for preventing misuse of a credit card, including: a credit/debit card adapted to be used for commercial transactions; a cash register adapted to send predetermined details of at least one commercial transaction involving a purchase with the credit/debit card to a provider of the credit/debit card; a handheld computing device adapted to receive the predetermined details or a portion thereof; and, a communication means between the provider and the handheld computing device.

In one aspect of the system, the cash register is further adapted to send the predetermined details or a portion thereof to the handheld computing device. In another aspect of the system, the cash register is further adapted to print a paper receipt of the transaction. In another aspect of the system, the receipt is adapted to include a code for identifying the at least one commercial transaction. In another aspect of the system, the code is adapted to be scanned by the handheld computing device. In another aspect of the system, the handheld computing device is adapted to include at least one application adapted to interpret the code. In another aspect of the system, the application is adapted to send confirmation of the at least one transaction to the provider. In another aspect of the system, the application is further adapted to receive a confirmation of the at least one transaction from the provider. In another aspect of the system, the handheld computing device is realized as a smartphone, a cellular phone, a tablet computer, a wearable computing device, a watch computing device, Google Glass, a laptop computer, or a mobile electronic device. In another aspect of the system, the communication means between a POS and the computing device is realized as cellular network, WiFi, IR, Bluetooth, RF, RFID, NFC, SMS, MMS, IP Push, sound signals or communication over application API.

In another aspect of the system, the code is realized as a bar code a QR code, a numerical code, an alphanumerical code, or a symbol code.

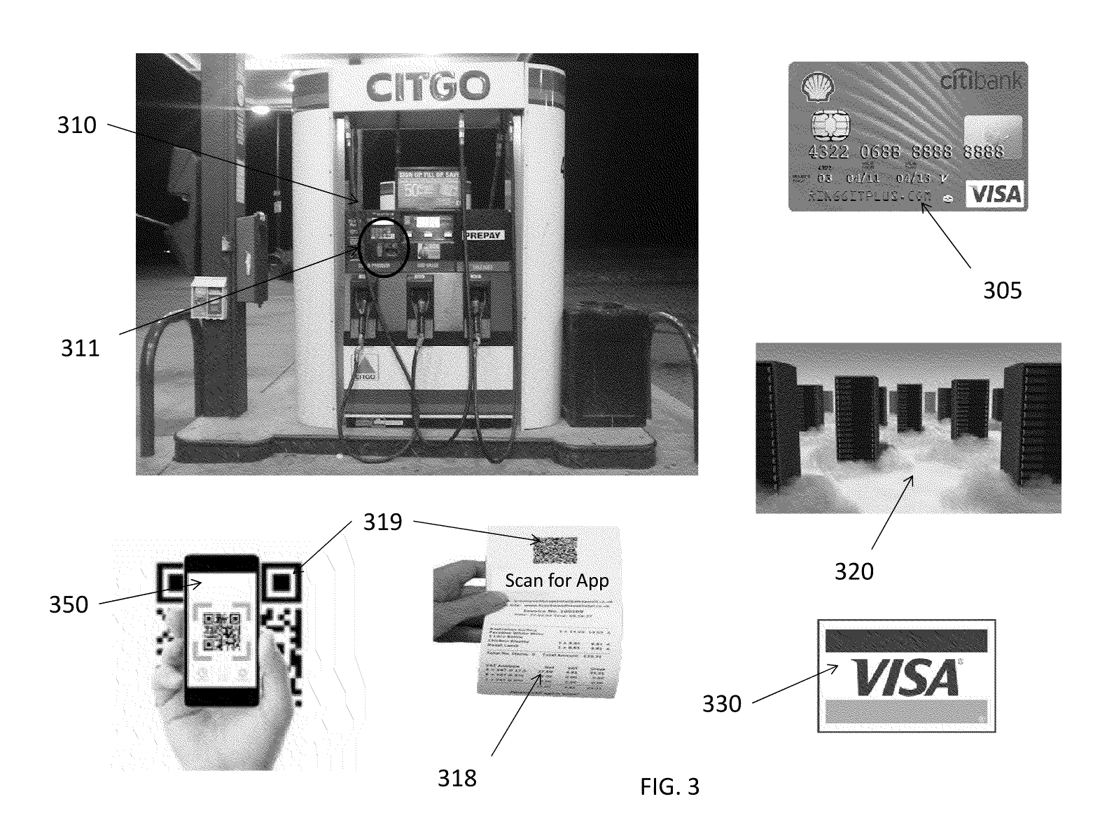

Attention is turned to FIG. 3. A user (not shown) has a credit card 305 adapted to be placed in a dedicated reader 311 of a cash register 310 associated with a gas pump. User buys gas and receives a receipt 318 that includes a code 319 adapted to be scanned by a smartphone 350 or similar mobile computing device. The cash register 310 is adapted to send data about the gas purchase, including the last four digits of the credit card 305, the date, the cost of the purchase, the location of the purchase and the pump number, to a cloud-based network 320 adapted to send the data to the card 305 provider 330, who then forwards said data or a portion thereof to the smartphone 350 via the telephone number unique or other identifier associated with the smartphone 350 and by extension, its user. The smartphone 350 compares data received from the provider 330 and the receipt. If the data are identical, the smartphone 350 is adapted to alert the provider 330 that the transaction is in order. If there are discrepancies or if data are missing from the receipt (for example, the receipt is illegible) or from the provider 330 (their servers are down), either the provider 330 and/or the smartphone 350 may contact the other to verify that a real transaction took place.

As most smartphone 350 include GPS chips and are adapted for GPS navigation, in some embodiments of the instant invention, the GPS location of a user at the time of a purchase may be sent to or requested by a provider 330 or may be confirmed by a provider 330, via an appropriate app on the smartphone. Thus, if provider 330 receives from cash register 310 details of a purchase with the credit card 305 and user smartphone 350 sends GPS data to provider 330 that puts user in the location of the purchase, provider 330 may approve the purchase based on the GPS data, in place of a receipt.

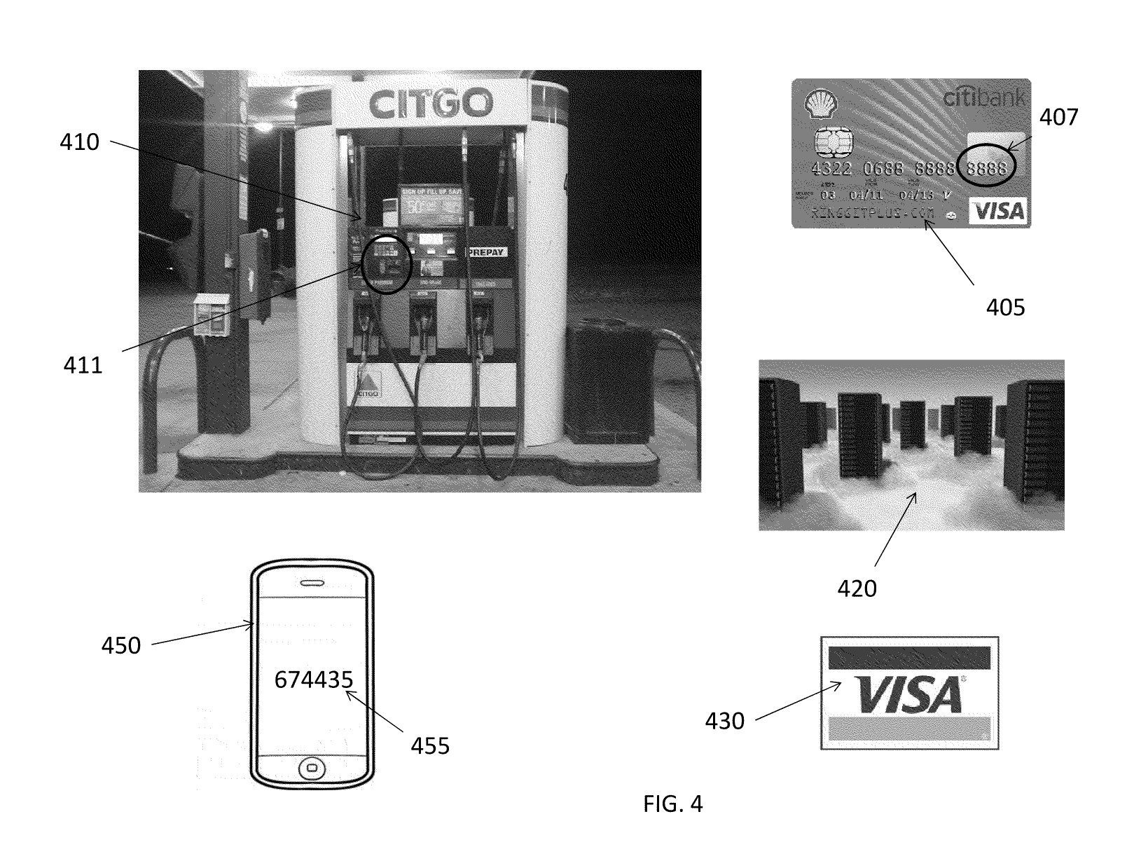

FIG. 4 shows an alternative set of conditions to the example provided in FIG. 3. A user (not shown) has a credit card 405 adapted to be placed in a dedicated reader 411 of a cash register 410 associated with a gas pump. The cash register 410 is adapted to send data about the gas purchase, including the last four digits 407 of the credit card 405, the date, the cost of the purchase, the location of the purchase and the pump number, to a cloud-based network 420 adapted to send the data to the card 405 provider 430, who then forwards said data to the smartphone 450 via the telephone number unique associated with the smartphone 450 and by extension, its user. The smartphone 450 receives an access code 455 to enter into the cash register 410. If the access code 455 is correctly entered, the cash register 410 is adapted to allow completion of the purchase of gas. If the access code 455 is not correctly entered, cash register 410 may be adapted not to work, as there is a concern that the credit card 405 and the smartphone 450 are not with a single individual, namely the owner of both. As such, the purchase is prevented beforehand and not analyzed after the fact.

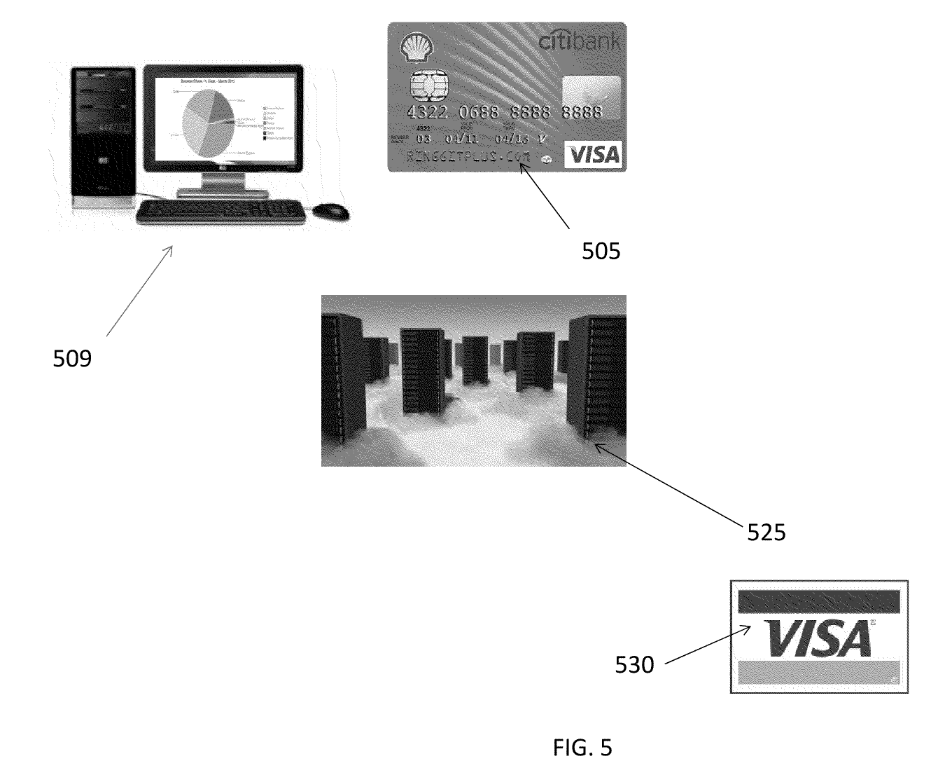

Attention is turned to FIG. 5. A user (not shown) accesses a computer 509 to hire via the Internet 325 the services of a lawyer. The user goes to the website of the lawyer in question and arranges to pay for the lawyer's services. The user enters the data (name on card, card type, number, expiration date, code on the backside) associated with his credit card 505. The transaction is completed when the lawyer's website or its associated payment portal, confirms the details of the card, including name and address of the card holder. In this instance, there may be a virtual receipt produced after the payment; the receipt's data may be used to compare payment data on the user's screen with data sent by the card 305 provider 330 via unique email, SMS or other means to user. Alternatively, the provider 330 may send the user an email and/or an SMS or other form of communication to confirm with him that he did really order the lawyer's services recently billed to his card. In all cases, there is communication between the card 505 owner and the card 505 provider 530 either prior to or after the completion of a credit card 505 transaction to verify in real-time that the owner of the credit card 505 is the one who really made the online purchase recorded by the credit card 505 provider 530.

### Third Embodiment

The invention includes a system for preventing misuse of a means of payment, including: a means of payment adapted to be used for commercial transactions; a cash register adapted to send details of at least one commercial transaction involving a purchase with the means of payment to a provider of the means of payment; a receipt produced by the cash register, the receipt adapted to include a code identifying details related to the at least one commercial transaction; a handheld computing device adapted to receive the information or a portion thereof; and, a communication means between the provider and the handheld computing device.

In one aspect of the system, the code is a QR code, a bar code, a alphanumeric code, or a symbol code. In another aspect of the system, the receipt is realized as a digital receipt on the handheld computing device.

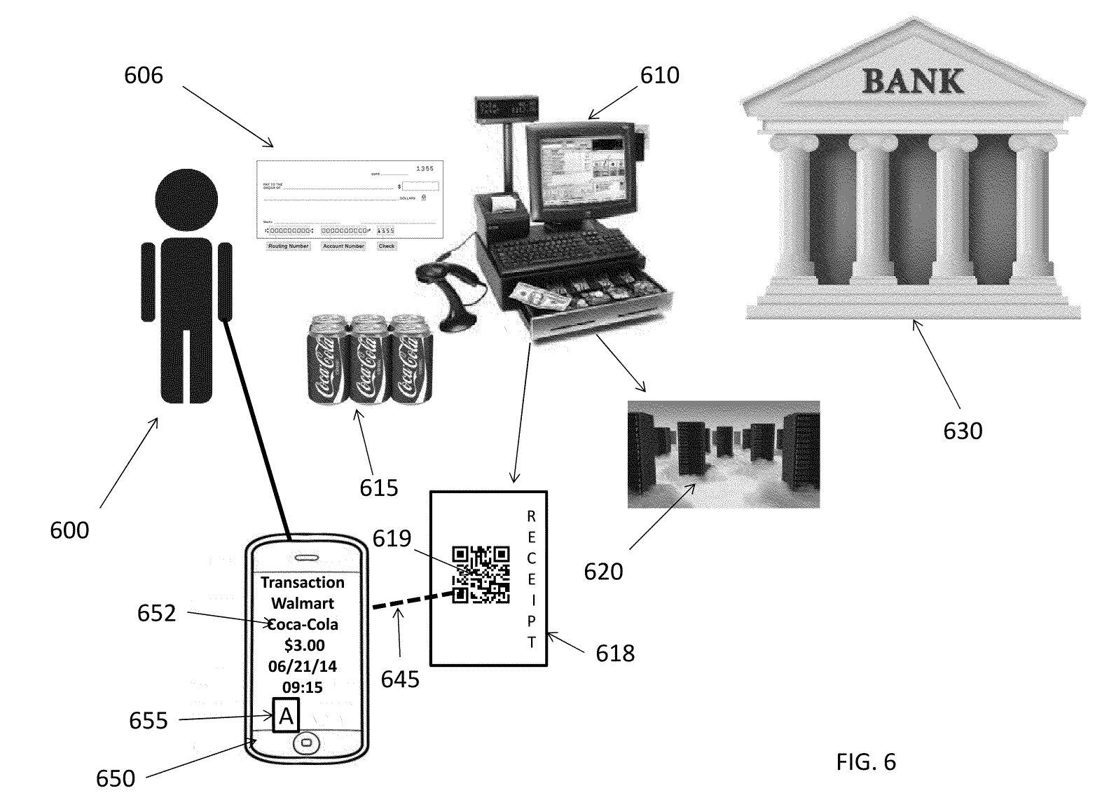

The instant embodiment may be applied to means of payment other than credit cards. Attention is turned to FIG. 6. A user 600 makes a purchase of an item 615 and pays with an account-based check 606 or other payment instrument such as PayPal, money order, wire transfer or the like. The cash register 610 handling the transaction produces a physical receipt 618 which includes a code 619 adapted to be read by user 600 smartphone 650 only (the user 600 having given his/her telephone number to a clerk at the cash register 610, or alternatively, the transaction includes the smartphone 650 telephone number data). The smartphone 650 scans 645 the code 619 on the receipt 618, and on the smartphone 650 graphical user display 652 appears details of the purchase: what item 615 was purchased, how much money (via check) 606 was tendered and how much change was given. Additional details such as date and time, check number, cash register number and clerk identifier may also be provided. The data associated with the purchase of the item 715 may be sent to the bank 630 associated with the check 606 either by the cash register 610 and/or by an associated network (620). The bank 630 may contact the smartphone 650 or the smartphone 650 may contact the bank 630 to corroborate the veracity and validity of the purchase of the item.

FIG. 7 shows a similar arrangement as shown in FIG. 6, except where the receipt 718 is virtual and sent wirelessly directly from the cash register 710 or related server 720 to the smartphone 750, where the details may be displayed. In this embodiment, the cash register 710 may be further adapted to send details of the purchase, including details identifying the user 700 to a third party vendor 799 (in addition to the bank 730 associated with the check 706 account), whose product 715 may have been purchased. Sending of this information may require approval of user 700 and may allow user to receive coupons from the third party vendor 799 and/or the store where the purchase of product 715 was made. The vendor 799 receives 777 real-time data as to the sale of its product 715. An application 755 may be included with the smartphone 750 to allow for organizing and analyzing purchase data as that provided by the scanned receipt 718. Data may optionally be sent to a network 720 for long-term or short-term storage. The data associated with the purchase of the item 715 may be sent to the bank 730 associated with the check 706 by the cash register 710 or associated network (620). The bank 730 may contact the smartphone 750 or the smartphone 750 may contact the bank 730 to corroborate the veracity and validity of the purchase of the item 715.

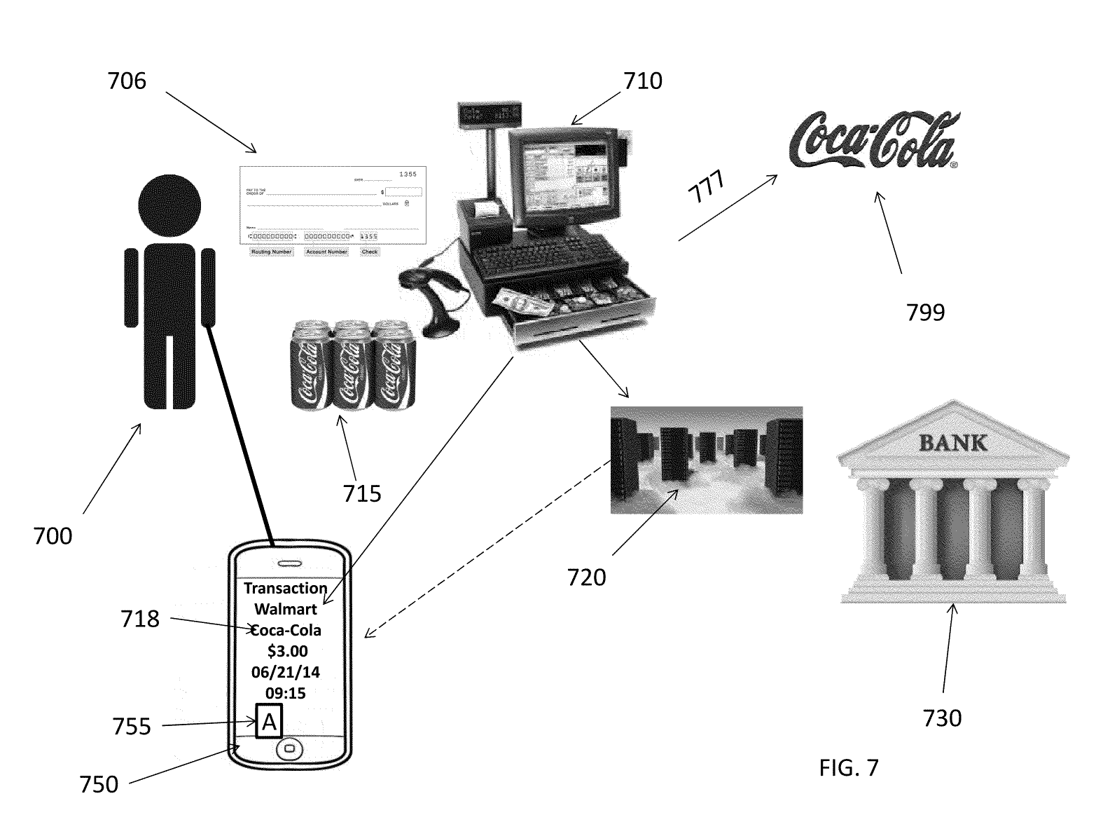

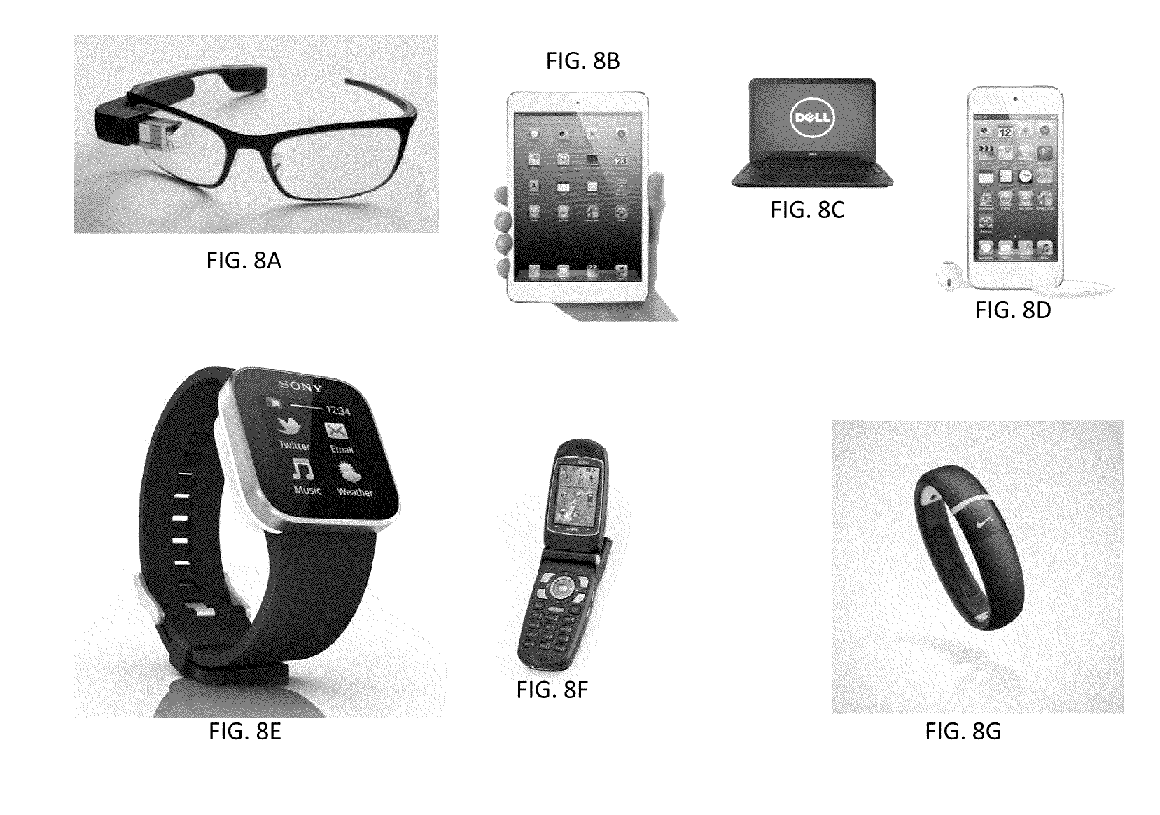

Attention is sent to FIG. 8A. A mobile computing device has been described primarily as a smartphone in previous embodiments. Yet, other elements such as Google Glass (FIG. 8A), tablet computer (FIG. 8B), laptop computer (FIG. 8C), mobile electronic device like an iPod Touch (FIG. 8D), smart watch (FIG. 8E), cellular phone (FIG. 8F), or wearable electronic device (FIG. 8G) or the like may fulfill the role of mobile computing device.

It is understood that the instant invention may be applied to any form of financial transaction that is traceable including but not limited to credit cards, debit cards, checks, wire transfers, money transfers, some cash transactions, traveler's checks, and the like. It is understand that a credit card may be realized as a plurality of credit cards. Said plurality of credit cards may belong to a single person, a group of people such as members of a single household, a group, corporation or other body. The instant invention, in some embodiments, may be used to manage/confirm all financial transactions of an individual, family, group, or company. Some embodiments, for example, may inform a parent or group leader or a purchase on a card by a family member or group associate. The parent or group leader may be passively informed or may be asked to confirm and/or allow the transaction. It is also understood that in some embodiments, if there is a mismatch between a user of a credit/debit card or the like and a provider of the same. regarding at least one transaction, communication from user to provider or provider to user may be encouraged or obligate to rapidly address a potential mistake and/or fraud. It may be that provider's servers are down and cannot record a transaction that a user's smartphone pushes (for example only); alternatively, there may be actual fraud and a phone call or the like may be encouraged and/or initiated to clarify the subject.

It is understood that embodiments of the instant invention may allow for calculating a credit score in part or in toto. For example, if a user consistently has her transactions confirmed by provider immediately after their completion, her credit worthiness may improve due to the low risk associated with her and her purchasing profile. In some embodiments, provider may use user performance to suggest improved or alternative credit arrangements and/or send data about a user to another provider of credit so that the latter may offer/encourage the same.

In some embodiments of the invention, a user may define a maximum monthly (or other timely) expense on a credit/debit card. Provider will be instructed to either deny a transaction that exceeds the predetermined cutoff limit and/or provider or user may communicate to the other that the limit has been exceeded and that either a proposed transaction be forbidden and/or allow for shutting down the card in question. A user or a provider may change a credit/debit card limit as per conditions and requirements defined by any agreement between provider and user. In some additional embodiments, a user and/or provider may prevent a transaction from being allowed to take place at certain locations or stores. Thus, a cash register may be informed by provider not to allow a transaction to take place; or, should the transaction take place, provider will immediately inform user (and/or others as described above for a parent or manager) of a purchase at a forbidden location.

Pre-set rules for allowing or disallowing a transaction may include: forbidden locations (stores/chains/expense categories, as black listed and/or based on allowed white list of allowed entities), exceeding the allowed total aggregate expense sum for a given card or for all cards associated with a given user for a defined expense period, purchase at forbidden geographical locations (e.g. purchase in another state. based on white list and/or black list, possible identified by user smartphone GPS), purchases online (allowed/disallowed), purchases over the phone or in any other form without presenting a physical credit/debit card (allowed/disallowed), purchases at forbidden times such as non-working days or at a forbidden time during the day (after 11 pm or before 7 am, for example), or the like.

It is emphasized that all of the above rules can be applied even without card vendor/provider, as well as for aggregate of competing card vendors/providers for user or groups of users, based on aspects of the invention, generally when a user is using an application to direct card expenses into the application. It is noted that said application can encourage a user to add card expenses into the application, if a manager or head of family will get a report at end of period of all expenses that were actually made but not reported to the application.

It is understood that instructions as described generally herein may be applied generally or specifically to a plurality of cards, with rights for ascribing proscriptions given to a card user or authorized individual, such as a parent of a minor or a boss of an employee. Such arrangements may, in certain circumstances, allow a provider—prior, during, or immediately after a transaction—suggest which of a plurality of cards or the like might be best to use to either avoid going over a predetermined maximum or allow for greatest reward points, miles or the like.

In some embodiments of the invention, communication between user and provider may occur prior to a transaction to verify that a card is operable and/or to provide suggestions as to which card of a plurality of cards might be best to use for improved price and/or discounts, points, miles, or the like. Said communication may occur via SMS, email, or the like. Such communication may be performed directly between a user and a provider without any information from a cash register or associated server/network.

It is expected that during the life of a patent maturing from this application, additional systems and methods for providing immediate feedback for purchases, for safety and/or for bookkeeping, may be developed, and the scope of the term of the invention is intended to include all such new technologies a priori.

It is appreciated that the instant invention, in some embodiments, may be applied to ATM and similar machines. Specifically, taking out money or performing another financial transaction at an ATM, teller, or other relevant location may be recorded either in a physical receipt or via a virtual receipt sent to a smartphone or similar device as well as to a bank or debit/credit card provider. Thus, the instant invention does not require a direct financial transaction of money or money equivalents for a good or service; the instant invention may also be applied when money is deposited, removed, or transferred.

In some embodiments of the instant invention, there may a step of comparing a monthly (or other) statement with transactions that have been confirmed via embodiments described specifically or otherwise herein. So, for example, a VISA card owner may receive by mail or electronically a statement on the 15^{th} of every month as to card activity. Of the thirty transactions listed on a given statement, some in person, others by phone or Internet, only 23 have been confirmed by one means or another between the user (via her smartphone) and the VISA card provider, namely user's bank. The other seven transactions are highlighted as “unconfirmed” and the user may be prompted to confirm the transaction or initiate a fraud complaint. The matching between confirmed transactions and monthly or other reports may be performed automatically by an application or the like.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of embodiments with differentially sized cases as herewith described. The instant invention may be employed for fixed locations, mobile payment systems or other arrangements not directly described herewith.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Certain embodiments of the instant invention may include design features that allow for easy attachment and removal of an electrical device to and from a case.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A system for preventing misuse of a credit card, including:
a credit/debit card adapted to be used for commercial transactions;
a cash register adapted to send predetermined details of at least one commercial transaction involving a purchase with said credit/debit card to a provider of said credit/debit card;
a handheld computing device adapted to receive said predetermined details or a portion thereof; and,
a communication means between said provider and said handheld computing device.

2. The system according to claim 1, wherein said cash register is further adapted to send said predetermined details or a portion thereof to said handheld computing device.

3. The system according to claim 1, wherein said cash register is further adapted to print a paper receipt of said transaction.

4. The system according to claim 3, wherein said receipt is adapted to include a code for identifying said at least one commercial transaction.

5. The system according to claim 4, wherein said code is adapted to be scanned by said handheld computing device.

6. The system according to claim 5, wherein said handheld computing device is adapted to include at least one application adapted to interpret said code.

7. The system according to claim 6, wherein said application is adapted to send confirmation of said at least one transaction to said provider.

8. The system according to claim 7, wherein said application is further adapted to receive a confirmation of said at least one transaction from said provider.

9. The system according to claim 1, wherein said handheld computing device is realized as a smartphone, a cellular phone, a tablet computer, a wearable computing device, a watch computing device, Google Glass, a laptop computer, or a mobile electronic device.

10. The system according to claim 1, wherein said communication means is realized as cellular network, WiFi, IR, Bluetooth, RF, RFID, NFC, SMS, MMS, IP Push, sound signals or communication over application API.

11. The system according to claim 4, wherein said code is realized as a bar code a QR code, a numerical code, an alphanumerical code, or a symbol code.

12. A method for preventing credit card fraud, including:
providing a credit/debit card;
performing a purchase of at least one good or service with said credit/debit card via a cash register;
sending predetermined details of said purchase to a provider of said credit/debit card;
sending said predetermined details of said purchase to a handheld computing device associated with an owner of said credit/debit card; and,
exchanging information regarding said purchase between said provider and said handheld computing device to confirm a validity of said purchase.

13. The method according to claim 12, wherein said sending predetermined details is performed by said cash register or a server in communication with said cash register. predetermined details is not performed.

14. The method according to claim 12, further including a step of sending a subset of said predetermined details to at least one third party.

15. The method according to claim 12, wherein said credit/debit card is realized as a plurality of credit/debit cards.

16. The method according to claim 15, wherein said plurality of credit/debit cards is associated with a single or a plurality of users.

17. The method according to claim 16, wherein said plurality of users is realized as members of a family, organization, company, country, group, or industry.

18. A system for preventing misuse of a means of payment, including:
a means of payment adapted to be used for commercial transactions;
a cash register adapted to send details of at least one commercial transaction involving a purchase with said means of payment to a provider of said means of payment;
a receipt produced by said cash register, said receipt adapted to include a code identifying details related to said at least one commercial transaction;
a handheld computing device adapted to receive said information or a portion thereof; and,
a communication means between said provider and said handheld computing device.

19. The system according to claim 18, wherein said code is a QR code, a bar code, a alphanumeric code, or a symbol code.

20. The system according to claim 18, wherein said receipt is realized as a digital receipt on said handheld computing device.
